(19) United States
(12) Patent Application Publication
(10) Pub. No.: US 2021/0025748 A1
(43) Pub. Date: Jan. 28, 2021

(54) METHOD AND APPARATUS FOR REAL-TIME DETECTION OF THE LEVEL OF A CRYOGENIC LIQUID IN A CONTAINER THEREOF

(71) Applicant: GOLD SIM (BEIJING) INTERNATIONAL CO., LTD, Beijing (CN)

(72) Inventor: LINGXI LI, Beijing (CN)

(21) Appl. No.: 16/520,477

(22) Filed: Jul. 24, 2019

(51) Int. Cl. G01F 23/58; F17C 13/02; G01F 23/76

(52) U.S. Cl. CPC G01F 23/58; F17C 13/02; G01F 23/76; F17C 2205/0161; F17C 2250/0491; F17C 2223/0161; F17C 2221/014; F17C 2250/0413

(57) ABSTRACT

Method and apparatus for real-time detection of the level of the cryogenic liquid in a container. The cryogenic liquid level detection apparatus includes a liquid level indicator, a floating scale, and a buoy attached at a bottom end of the floating scale. A top end of the floating scale moves against calibrated markings of the liquid level indicator, thereby indicating the level of the cryogenic liquid in real-time.

### FIELD OF THE INVENTION

The present invention relates to the field of applications using cryogenic fluid (e.g., cryo-preservation or cryo-conservation). In particular, the invention relates to method and apparatus for detecting the level of a cryogenic fluid, such as liquid nitrogen, in a container thereof.

### DESCRIPTION OF THE PRIOR ART

Preservation of the biological samples is critical for their use in clinical and research applications. In most biological and medical laboratories, preservation helps for the later use of the biological samples to develop the solutions to the biological problems and continue the research and development applications for the advancement of medical engineering. The samples are cryo-preserved or cryo-conserved.

Typically, the samples are preserved in a low-temperature bath of the cryogenic liquids (approximately −80° C. when solid carbon dioxide is used or −196° C. using liquid nitrogen). To maintain these low temperatures the freezers (more particularly liquid nitrogen freezers) are required. FDA Regulation Part 211 subpart D, Equipment-211.68 part 610 requires these freezers to regularly check the liquid level every day in order to make sure the samples are stored in a safe temperature. This is usually done by a third party mechanical measurement of the liquid level. A lab operator opens the lid of the freezer and inserts a wooden ruler in the liquid nitrogen freezer and manually checks the frost deposit on the wooden ruler in order to identify the level of liquid nitrogen level. During this process, the opening of the lid of the liquid nitrogen freezers results in the loss of the liquid nitrogen. Further, the opening of the lid allows the inflow of the outside atmospheric air into the internal environment of the freezers where the samples are kept for preservation. This inflow of the air affects the temperature in the freezer and the samples to be cryo-preserved.

In some cases, the conventional method of detecting the level of the cryogenic liquid with a wooden ruler is not reliable as the frost deposits are not obvious to the lab operator, thereby creating a need for the repeated measurements in order to accurately detect the level of the cryogenic liquid. The drawbacks of using the conventional wooden ruler also include the need for the wooden rice ruler to be placed vertically and exactly at the same location every time for the measurement by the operator. This further increases the chance of errors wherein the measurement results are affected by human factors.

Other systems include the use of the electrical sensors, optical level switches, ultrasonic sensors, etc. to detect the changes in the level of cryogenic liquid in the freezers. These systems/methods are available with a relatively high installation cost having limited lifetime. Further, the freezers associated with these installed systems still need to comply with FDA regulations.

### SUMMARY OF THE INVENTION

An object of the present invention is to provide a cryogenic liquid level detection method that can accurately and quickly measure the amount of cryogenic liquid in a container in real-time.

Another object of the present invention is to provide a built-in cryogenic liquid level detecting apparatus comprising a buoy attached at the bottom of a floating scale and the floating scale is movable against the calibration markings of a liquid level indicator to indicate the level of cryogenic liquid in a container.

Yet another object of the present invention is to provide a real-time cryogenic liquid level detecting apparatus which detects the level of the cryogenic liquid in a container without opening the lid of the container, thereby avoiding any human influence on the measurement, preventing loss of the cryogenic liquid and without disturbing the internal environment of the liquid nitrogen container.

Yet another object of the present invention is to provide a cryogenic liquid level detecting apparatus which safely calculates the level of the cryogenic liquid in a container in real-time without exposing the human directly to the cryogenic liquid in the container, ensuring safety against human damages such as frost bites.

Yet another object of the present invention is to provide a cryogenic liquid level detecting apparatus for detecting the level of the cryogenic liquid in a container which is cost effective and requires less maintenance as it does not involve usage of expensive electric or electronic components such as batteries, sensors etc.

Yet another object of the present invention is to provide a built-in cryogenic liquid level detecting apparatus for detecting the level of the cryogenic liquid in a container which determines the level of the cryogenic liquid in the container using mechanical components only.

Yet another object of the present invention is to provide a liquid level indicator with calibration markings that indicates the level of the cryogenic liquid in the container, wherein the calibrated markings are easy to observe with naked eye.

Yet another object of the present invention is to provide a cryogenic liquid level detecting apparatus for detecting the level of cryogenic liquid in the container without affecting the internal environment of the container through the use of moisture and leakage resistant seals and low heat conductivity materials of floating scale, floating scale cover and insulation jacket.

Yet another object of the present invention is to provide a floating scale that moves against the calibrated markings of the liquid level indicator to visually indicate the level of the cryogenic liquid in a container.

Yet another object of the present invention is to provide a buoy that does not change its shape in cryogenic liquid over time and is long lasting.

Yet another object of the present invention is to provide a floating scale cover with a plurality of orifices to ensure smooth and uniform ingress and egress of the cryogenic liquid in the floating scale cover, ensuring stable and uniform measurements of the level of the cryogenic liquid in a container, thereby avoiding error(s) due to the uneven cryogenic level change or splashing of the cryogenic liquid in the container.

In an embodiment, an apparatus for real-time detection of the level of a cryogenic liquid (or fluid) in a container is provided which comprises a buoy such that the density of the buoy is less than the density of the cryogenic liquid, a floating scale such that the density of the floating scale is less than the density of the cryogenic liquid, a liquid level indicator with calibrated markings and a floating scale cover which at least partially encloses the floating scale and completely encloses the buoy. The buoy is in contact with the cryogenic liquid of a cryogenic liquid compartment. The buoy is attached at the bottom of the floating scale such that the assembly is configured to move only in a vertical direction between two end positions i.e., a top end position which corresponds to the highest level of the cryogenic liquid in the container and a bottom end position which corresponds to the lowest level of the cryogenic liquid in the container.

In yet another embodiment of the present invention, a method of real-time detection of the level of a cryogenic liquid in a container having a liquid level indicator located outwardly on an upper end of the container, the liquid level indicator comprising calibrated markings, the method comprising the steps of
a) positioning a floating scale having a top end and a bottom end attached with a buoy such that the top end of the floating scale in disposed in the liquid level indicator; and
b) detecting the level of the cryogenic liquid in the container by the position of the top end of the floating scale enclosed in the liquid level indicator relative to the calibrated markings on the liquid level indicator wherein the movement of the floating scale in a vertically upward or a vertically downward direction is based on the cryogenic liquid level in the container.

The system provided is robust, simple to use, time saving, low cost, easy to assemble, safe, accurate and efficient for detection of the level of the cryogenic liquid in the container.

From the foregoing disclosure and the following more detailed description of various embodiments, it will be apparent to those skilled in the art that the present invention provides a significant advancement in the art of the level detection for cryogenic liquid. Particularly significant in this regard is the potential the invention affords for providing a relatively reliable, accurate, and low cost liquid level detection apparatus for cryogenic liquids in cryogenic liquid containers. Additional features and advantages of various embodiments will be better understood in view of the detailed description provided below.

### BRIEF DESCRIPTION OF THE DRAWINGS

FIG. 1 is a front section view of a cryogenic liquid level detection apparatus in a container according to an embodiment of the present invention.

FIG. 2 is a front view of a cryogenic liquid level detection apparatus as illustrated in FIG. 1.

FIGS. 3a, 3b and 3c are side views of certain floating scale and buoy assemblies according to embodiments of the present invention.

FIGS. 4a, 4b, and 4c are top views of certain floating scale and buoy assemblies according to embodiments of the present invention.

FIGS. 5a, 5b and 5c are front section views of a container with different positions of the floating scale according to embodiments of the present invention.

FIG. 6 is a front section view of the liquid level indicator in a container according to another embodiment of the present invention.

FIG. 7 is a front section view of a container showing a buoy in contact with the cryogenic liquid according to some embodiments of the present invention.

FIG. 8 is a front section view of a container showing the liquid level indicator with calibrated markings according to some embodiments of the present invention.

### DESCRIPTION OF PREFERRED EMBODIMENT

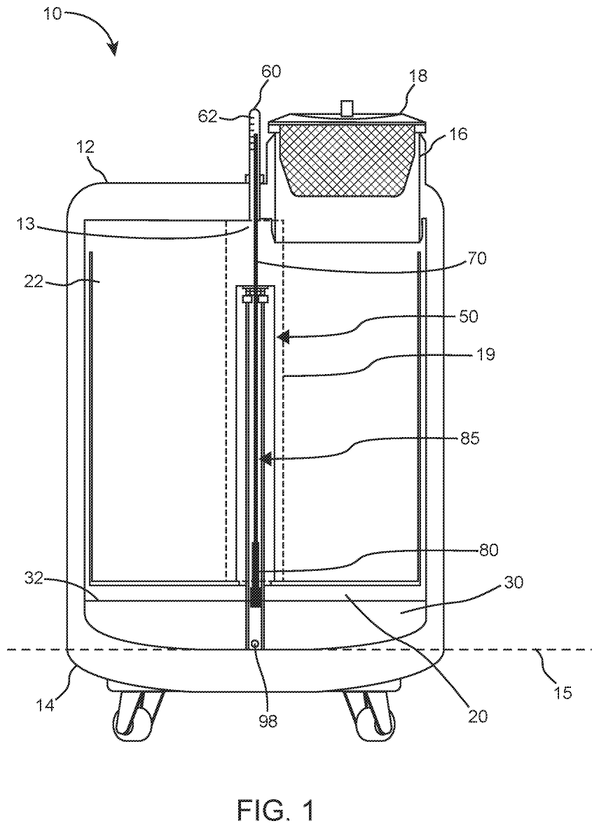

Referring now to the figures, a container 10 is shown in the FIG. 1. The container 10 has an upper end 12, an opening 13, a lower end 14, a lowest point 15, an access port 16, a lid 18, a longitudinal hollow compartment 19 having both the ends open, a cryogenic liquid compartment 20, and a storage compartment 22. The container 10 is filled with a cryogenic liquid 30 in the cryogenic liquid compartment 20 and the storage compartment 22 is used for the storage of samples. The lowest point 15 refers to the datum inside the container 10 above which the level of the cryogenic liquid 30 is measured. The cryogenic liquid level 32 denotes the upper level of the cryogenic liquid 30. The samples are provided in the storage compartment 22 through the access port 16 by opening the lid 18. Similarly, the samples can be unloaded from the container 10 through the access port 16. The container 10 can be a vapor phase cryogenic liquid freezer, a vessel, or a tank that is used to preserve the samples. The samples can include biological cells, for example stem cells or any other cells or other materials that requires cryo-preservation and is known to a person skilled in the art. In a preferred embodiment, the cryogenic liquid 30 stored in the cryogenic liquid compartment 20 is liquid nitrogen.

The longitudinal hollow compartment 19 is centrally located in the container 10 and is vertically above the lowest point 15 as shown in FIG. 1 according to a preferred embodiment of the invention. However, other possible locations are also possible as obvious to a person skilled in the art.

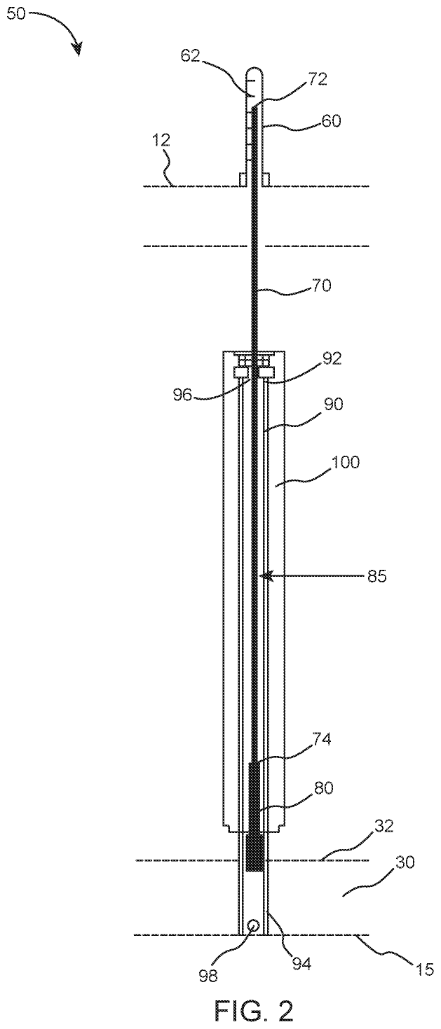

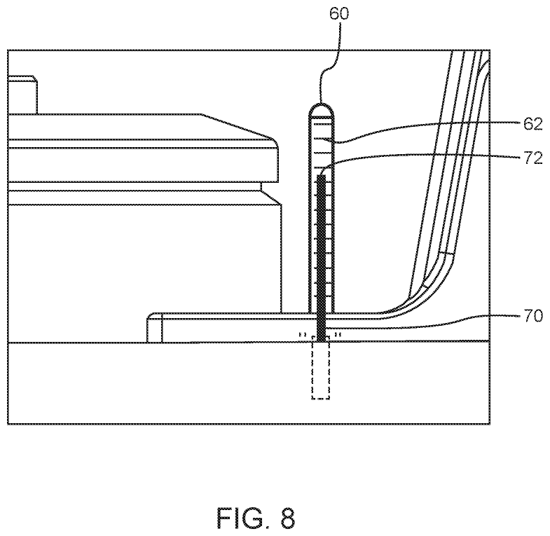

As shown in FIG. 1, a cryogenic liquid level detection apparatus 50 comprises a liquid level indicator 60, a floating scale 70 and a buoy 80. The cryogenic liquid level detection apparatus 50 is disposed centrally in the longitudinal hollow compartment 19 of the container 10 and is sealed within. The arrangement is such that from the upper open end of the longitudinal hollow compartment 19, the floating scale 70 protrudes outward into the liquid level indicator 60, and from the lower open end of the longitudinal hollow compartment 19 the buoy 80 protrudes outward in the cryogenic liquid compartment 20 as shown in FIG. 1 and FIG. 2. As shown in FIG. 8, the liquid level indicator 60 includes calibrated markings 62 with an accuracy of 1 mm. The liquid level indicator 60 is a hollow cylinder opened at one end. In a preferred embodiment, the liquid level indicator 60 is made of polymethyl methacrylate. The liquid level indicator 60 is transparent such that the level of the cryogenic liquid 30 is clearly indicated by the cryogenic liquid level detection apparatus 50.

Referring back to FIG. 1, the liquid level indicator 60 is affixed above the opening 13 in the upper end 12 of the container 10 such that the open end of the liquid level indicator 60 coincides with the opening 13 of the container 10. The liquid level indicator 60 is located outside of the container 10 and is vertically above the floating scale 70. The opening 13 near the upper end 12 of the container 10 (and on top of the storage compartment 22) permits the floating scale 70 to slide through in the liquid level indicator 60. The movement of the floating scale 70 can be restricted in a vertically upward and vertically downward direction only.

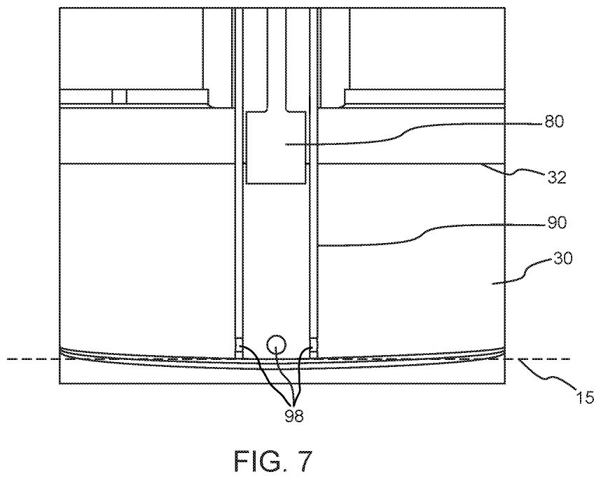

FIG. 2 shows a front view of the cryogenic liquid level detection apparatus 50. The floating scale 70 has a top end 72 and a bottom end 74. The top end 72 is disposed in the liquid level indicator 60 (as more clearly shown in FIG. 8). The bottom end 74 is attached to the buoy 80 (the buoy is preferably shown in a different shading/pattern to distinguish from the floating scale). The buoy 80 floats on the cryogenic liquid 30 stored in the cryogenic liquid compartment 20 of the container 10 as shown in FIG. 7. A floating scale cover 90 is provided to house the floating scale 70 and the buoy 80. The floating scale cover 90 is sealed inside the longitudinal hollow compartment 19 of the container 10 to avoid humidity and an insulation jacket 100 is provided to minimize heat exchange between the floating scale cover 90 and the container 10. The floating scale cover 90 has a head 92, a base 94, and a plurality of orifices 98. The base 94 is affixed at the lowest point 15 inside the container 10. The head 92 has an aperture 96 allowing the floating scale 70 to protrude outwardly from the head 92. The aperture 96 can be constructed to be just slightly larger than the diameter of the floating scale 70 with friction characteristics such that the floating scale 70 can smoothly and effortlessly moves up and down through the aperture 96 when the attached buoy rises or falls with the changing level of the cryogenic fluid. The insulation jacket 100 is attached to the floating scale cover 90 along the entire length. The insulation jacket 100 externally surrounds the floating scale cover 90 in the longitudinal hollow compartment 19 of the container 10. The material of the insulation jacket 100 can be selected such that insulation jacket 100 minimizes heat transfer to maintain the conditions (such as pressure, temperature, humidity) in the internal environment of the container 10. In a preferred embodiment, the insulation jacket 100 and the floating scale cover 90 are constructed as a one-piece component. In another embodiment, the insulation jacket 100 and the floating scale cover 90 are attached to each other in a non-permanent fashion, for example, through fasteners such as screws etc.

In the embodiment shown in FIG. 2, the floating scale cover 90 completely encloses the buoy 80 and a part of the floating scale 70 is inside the floating scale cover 90. In an alternative embodiment, the floating scale cover 90 completely surrounds the floating scale 70 and the buoy 80, as shown in FIG. 6.

The floating scale cover 90 has the dimensions slightly greater than the dimensions of the buoy 80 and the floating scale 70 to ensure the smooth movement of the floating scale 70 and the buoy 80 inside the floating scale cover 90 as shown in FIG. 7. The floating scale cover 90 can be made of polymethyl methacrylate. The floating scale cover 90 provides protection to the floating scale 70 and the buoy 80 from physical damage, and prevents the floating scale 70 and the buoy 80 from unwanted lateral displacement from its set position during either installation or transferring of the container 10 from one site to another site.

Referring to FIG. 2, the floating scale cover 90 has a plurality of orifices 98. The plurality of orifices 98 are present at the base 94 of the floating scale cover 90 close to the lowest point 15 of the container 10. The plurality of orifices 98 are located in the cryogenic liquid compartment 20 of the container 10, and are provided to allow free flow of the cryogenic liquid 30 in and out of the floating scale cover 90. This free flow of the cryogenic liquid 30 prevents unstable readings during measurement of the level of the cryogenic liquid 30. The unstable readings may arise due to splashing of the cryogenic liquid 30 at the time of filling the container 10. The plurality of orifices 98 maintains an equal level of the cryogenic liquid 30 inside and outside of the floating scale cover 90 in the cryogenic liquid compartment 20.

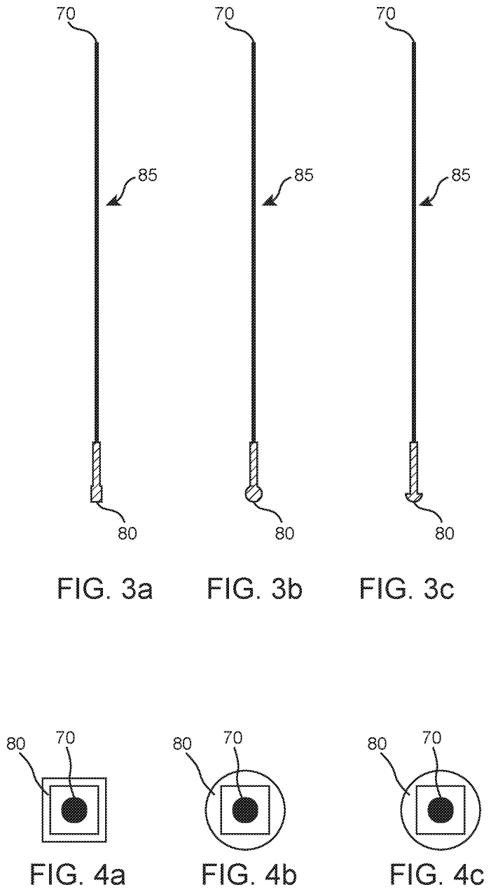

FIGS. 3a, 3b and 3c illustrate an assembly 85 of the floating scale 70 and the buoy 80. The floating scale 70 has a circular cross-section according to an embodiment of the invention and is as shown in the FIGS. 4a, 4b and 4c. However, other cross-sections are also possible as known to a person skilled in the art, for example rectangular, square, etc. In a preferred embodiment, the floating scale 70 is made of glass fiber. The density of the floating scale 70 is less than the cryogenic liquid 30. The buoy 80 is made of a material and construction that is resistant to change in shape in the cryogenic liquid 30. In a preferred embodiment, the material of the buoy 80 is expanded polystyrene (EPS) material. The density of the buoy 80 is also less than the density of the cryogenic liquid 30 in the container 10. The buoy 80 can be of various shapes and sizes. FIG. 3a shows the floating scale 70 that has a circular cross-section and a cuboid shaped buoy 80 attached to it; FIG. 3b shows a spherical shape of the buoy 80; and FIG. 3c shows a hemi-spherical buoy 80 attached to the floating scale 70. Other geometries of the buoy 80 are also possible as known to a person skilled in the art. The top view of the assembly 85 is as shown in the FIGS. 4a, 4b and 4c.

The material(s) of construction of the floating scale 70 and the buoy 80 can be selected such that the assembly 85 of the floating scale 70 and the buoy 80 floats on the cryogenic liquid 30 in the floating scale cover 90 that enters or exits through the plurality of orifices 98 from or to the cryogenic liquid compartment 20. The assembly 85 floats inside the floating scale cover 90 due to the buoyant forces and the lower density of the assembly 85.

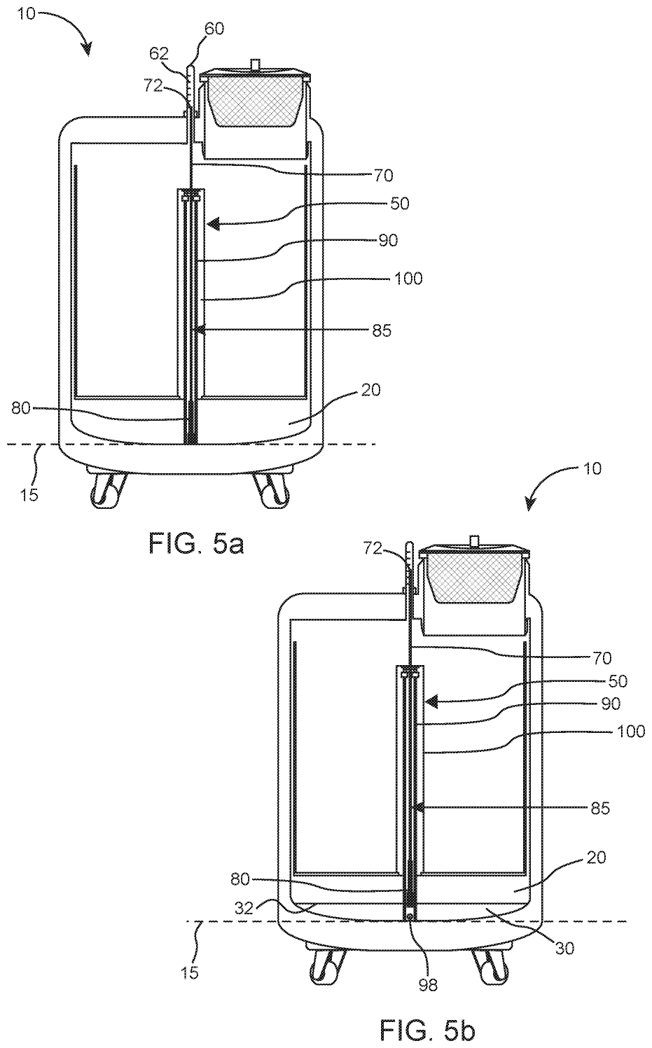

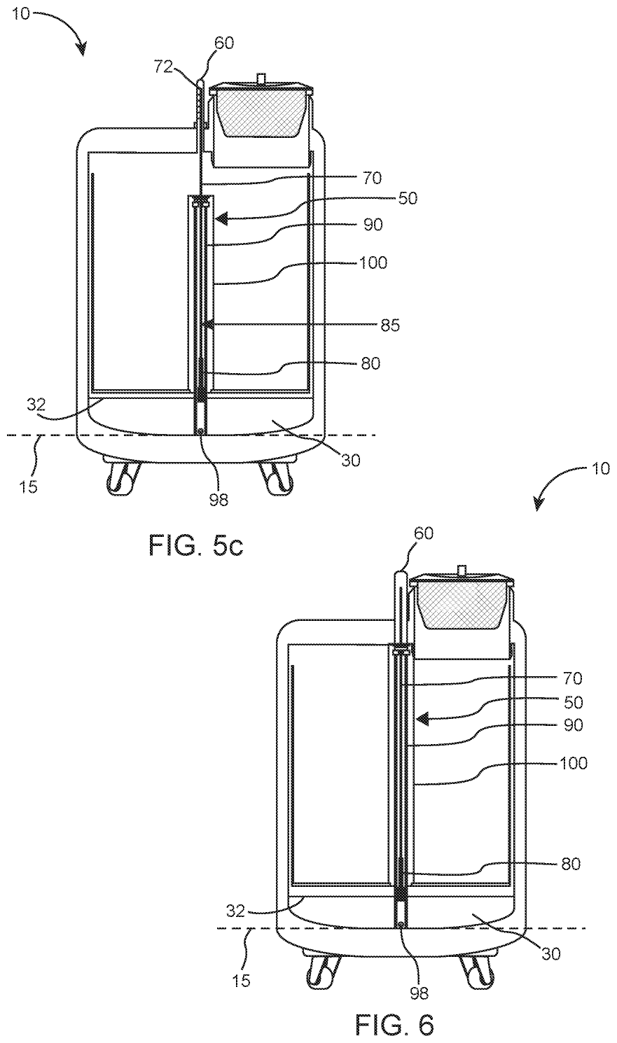

FIGS. 5a, 5b and 5c illustrates the functioning of the cryogenic liquid level detection apparatus 50 in the container 10 according to a preferred embodiment of the present invention. The cryogenic liquid level detection apparatus 50 is built-in with the container 10. The cryogenic liquid 30 is stored in the cryogenic liquid compartment 20 for the preservation of the samples in the storage compartment 22. The assembly 85 of the floating scale 70 and the buoy 80 is housed in the floating scale cover 90. The assembly 85 floats on the cryogenic liquid 30 due to the buoyant forces acting on the buoy 80 and the lower density of the assembly 85.

FIG. 5a illustrates the state when the cryogenic liquid compartment 20 is empty. The top end 72 of the floating scale 70 is positioned against a zero of the calibrated markings 62 of the liquid level indicator 60. This indicates that the container 10 is empty.

FIG. 5b illustrates the state when the cryogenic liquid 30 is supplied in the cryogenic liquid compartment 20. When the cryogenic liquid 30 starts filling in the cryogenic liquid compartment 20, the cryogenic liquid 30 flows into the floating scale cover 90. The flow of cryogenic liquid 30 is enabled through the plurality of orifices 98 at the base 94 of the floating scale cover 90. Due to this inward flow of the cryogenic liquid 30 in the floating scale cover 90, an equal level of the cryogenic liquid 30 is maintained inside of the floating scale cover 90 and in the cryogenic liquid compartment 20 where the floating scale cover 90 is disposed. Hence, the buoy 80 disposed inside the floating scale cover 90 comes in contact with the cryogenic liquid 30. The assembly 85 of the floating scale 70 and the buoy 80, configured to move in substantially only vertically direction (up or down), starts rising in vertical direction. As a result of this vertically upward movement of the assembly 85, the top end 72 of the floating scale 70 has moved upwards against the calibrated markings 62 of the liquid level indicator 60. Corresponding to the change in the level of the cryogenic liquid 30 as the cryogenic liquid 30 is supplied in the cryogenic liquid compartment 20, the top end 72 of the floating scale 70 moves against the calibrated markings 62. The movement of the top end 72 of the floating scale 70 ceases when the supply of the cryogenic liquid 30 is stopped. The calibrated markings 62 against which the top end 72 of the floating scale 70 stops indicate the level of the cryogenic liquid 30 in the cryogenic liquid compartment 20 or the container 10.

FIG. 5c shows the detected level of the cryogenic liquid 30 in the cryogenic liquid compartment 20 or the container 10 when the cryogenic liquid compartment 20 of the container 10 is full of the cryogenic liquid 30.

When the level of the cryogenic liquid 30 drops in the cryogenic liquid compartment 20, the cryogenic liquid 30 inside the floating scale cover 90 moves outwardly in the cryogenic liquid compartment 20 through the plurality of orifices 98 such that an equal level of the cryogenic liquid 30 outside of the floating scale cover 90 and inside of the cryogenic liquid compartment 20 is again maintained. This lowers the assembly 85 of the floating scale 70 and the buoy 80 in the floating scale cover 90. As a result of the lowering of the assembly 85, the top end 72 of the floating scale 70 moves vertically downwards against the calibrated markings 62 of the liquid level indicator 60. The calibrated markings 62 against which the top end 72 of the floating scale 70 stops indicates the level of the cryogenic liquid 30 in the cryogenic liquid compartment 20 or the container 10.

In another embodiment of the present invention, a method of real-time detection of the level of the cryogenic liquid 30 in a container 10 is described in detail according to FIG. 1. The method comprises a number of steps as illustrated.

The method of detection of the cryogenic liquid 30 level in the container 10 includes: providing the floating scale 70 in the container 10 (the density of the floating scale 70 is less than the cryogenic liquid 30 present in the cryogenic liquid compartment 20 of the container 10). The cryogenic liquid 30 in the container 10 is the liquid whose level is to be detected in real-time. The material chosen for the floating scale 70 can be glass fiber according to a preferred embodiment of the present invention. Other material can also be selected such that the density of the floating scale 70 remains always less than the cryogenic liquid 30 in the container 10. The floating scale 70 can have a circular cross-section as shown in FIGS. 4a, 4b and 4c according to a preferred embodiment of the invention. However, other shapes like square, rectangular, etc. as obvious to a person skilled in the art can also be used as other variants of the present invention.

The buoy 80 is attached to the bottom end 74 of the floating scale 70. The buoy 80 has a density less than the cryogenic liquid 30 in the container 10. The material of the buoy 80 can be selected such that the buoy 80 floats on the cryogenic liquid 30 in the container 10 when disposed in it (that is, at least a portion of the buoy 80 is exposed above the cryogenic liquid 30). For example, the material for buoy 80 can be expanded polystyrene (EPS). Other material can also be selected such that the density of the buoy 80 remains always less than the stored cryogenic liquid 30 in the container 10. The buoy 80 has a rectangular shape as shown in FIG. 3a according to a preferred embodiment of the invention. However, other shape and geometry for example, FIG. 3b showing the spherical shape of the buoy 80, FIG. 3c showing the hemi-spherical buoy 80 attached to the floating scale 70 can also be used.

The assembly 85 of the buoy 80 attached to the floating scale 70 is now disposed in the floating scale cover 90. The assembly 85 is disposed in the floating scale cover 90 in such a way that the top end 72 of the floating scale 70 protrudes outward from the aperture 96 in the head 92 of the floating scale cover 90. From the base 94 the buoy 80 is able to slide in a vertically upward and vertically downward direction.

The insulation jacket 100 is provided on the external surface of the floating scale cover 90. The insulation jacket 100 is such that insulation jacket 100 shields the cryogenic liquid level detection apparatus 50 from the heat exchange between the floating scale cover 90 and the container 10 while working.

The cryogenic liquid level detection apparatus 50 assembled is now centrally located in the longitudinal hollow compartment 19 of the container 10 and is sealed to prevent the influence of the external ambient environment like humidity.

The top end 72 of the floating scale 70 is placed in the liquid level indicator 60. As shown in FIG. 1 and FIG. 2, the liquid level indicator 60 is positioned above the floating scale 70. The top end 72 housed in the liquid level indicator 60 moves against the calibrated markings 62 to indicate the level of the cryogenic liquid 30 in the cryogenic liquid compartment 20 of the container 10. The liquid level indicator 60 can be made of polymethyl methacrylate and is transparent to clearly indicate the level of the cryogenic liquid 30. Other materials can also be selected for the liquid level indicator 60 as known to a person skilled in the art.

The level of the cryogenic liquid 30. When the level of the cryogenic liquid 30 changes in the cryogenic liquid compartment 20, the level of the cryogenic liquid 30 either rises or falls. This level of the cryogenic liquid 30 is maintained at equal level inside the floating scale cover 90 and the cryogenic liquid compartment 20 through the plurality of orifices 98. The cryogenic liquid 30 contacts the buoy 80 inside the floating scale cover 90. The assembly 85 floats on the cryogenic liquid 30 inside the floating scale cover 90 due to the buoyant forces acting on the buoy 80. The displacement of the assembly 85 occurs according to the change in the level of the cryogenic liquid 30 with which the assembly 85 is in contact.

The rise in the level of the cryogenic liquid 30 displaces the assembly 85 of the floating scale 70 and the buoy 80 in a vertically upward direction. As a result, the top end 72 of the floating scale 70 slides upward in the liquid level indicator 60 against the calibrated markings 62. The calibrated markings 62 against which the top end 72 of the floating scale 70 stops indicate the level of the cryogenic liquid 30 in the cryogenic liquid compartment 20 or the container 10.

As the level of the cryogenic liquid 30 starts falling, the assembly 85 of the floating scale 70 and the buoy 80 starts displacing in the vertically downward direction. As a result, the top end 72 of the floating scale 70 starts sliding downward in the liquid level indicator 60. The calibrated markings 62 against which the top end 72 of the floating scale 70 stops indicate the level of the cryogenic liquid 30 in the cryogenic liquid compartment 20 or the container 10.

The liquid level indicator 60 and the floating scale cover 90 according to a preferred embodiment of the invention are two individual components as shown in FIG. 1.

In another embodiment of the present invention, the liquid level indicator 60 and the floating scale cover 90 is a single component such that the single component completely encloses the floating scale 70 and the buoy 80 as shown in the FIG. 6.

One of the advantages of this invention is that the built-in detection mechanism is purely mechanical and easy to operate. The system can be particularly useful in the field of cryo-preservation of the biological cells where the level of the cryogenic liquid 30 needs to be checked regularly to comply with the FDA rules. The system also reduces human exposure to cryogenic fluid, thus safeguarding the operator from frost-bite and increasing his or her safety during the detection.

From the foregoing disclosure and detailed description of certain embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. An apparatus for real-time detection of the level of a cryogenic liquid in a container, the apparatus comprising;
a liquid level indicator attached at an upper end of the container;
a floating scale positioned in the container such that the floating scale is movable in vertical direction, wherein the floating scale comprises a top end enclosed in the liquid level indicator and a bottom end attached to a buoy; and wherein the density of the floating scale and the buoy is less than the density of the cryogenic liquid.

2. The apparatus according to claim 1, wherein the cryogenic liquid is liquid nitrogen.

3. The apparatus according to claim 1, wherein the container is a liquid nitrogen freezer.

4. The apparatus according to claim 1, wherein the liquid level indicator is located on the outside of the container.

5. The apparatus according to claim 1, wherein the liquid level indicator comprises calibrated markings.

6. The apparatus according to claim 1, wherein the floating scale is made of glass fiber.

7. The apparatus according to claim 1, wherein the buoy is made of expanded polystyrene (EPS) material.

8. The apparatus according to claim 1, wherein the buoy is resistant to change in shape in the cryogenic liquid.

9. The apparatus according to claim 1, further comprising a floating scale cover provided longitudinally around the buoy and at least a part of the floating scale.

10. The apparatus according to claim 9, further comprising an insulation jacket surrounding the floating scale cover.

11. The floating scale cover according to claim 9, wherein the floating scale cover comprises a plurality of orifices to maintain the equal level of the cryogenic liquid inside and outside of the floating scale cover in the container.

12. The floating scale cover according to claim 11, wherein the plurality of orifices are located at the bottom of the floating scale cover.

13. A method of real-time detection of the level of a cryogenic liquid in a container having a liquid level indicator located outwardly on an upper end of the container, the liquid level indicator comprising calibrated markings, the method comprising:
positioning a floating scale having a top end and a bottom end attached with a buoy such that the top end of the floating scale is disposed in the liquid level indicator; and
detecting the level of the cryogenic liquid in the container by the position of the top end of the floating scale relative to the calibrated markings on the liquid level indicator wherein the movement of the floating scale in a vertically upward or a vertically downward direction is based on the level of the cryogenic liquid in the container.

14. The method according to claim 13, wherein the cryogenic liquid is liquid nitrogen.

15. The method according to claim 13, wherein the container is a liquid nitrogen freezer.

16. The method according to claim 13, wherein the floating scale is made of glass fiber.

17. The method according to claim 13, wherein a floating scale cover is provided longitudinally around the buoy and at least a part of the floating scale.

18. The method according to claim 13, wherein an insulation jacket surrounds the floating scale cover.

19. The method according to claim 13, wherein the floating scale cover comprises a plurality of orifices to maintain the equal level of the cryogenic liquid inside and outside of the scale cover in the container.

20. The method according to claim 13, wherein the plurality of orifices are at the bottom of the floating scale cover.
